(19) United States
(12) Patent Application Publication
(10) Pub. No.: US 2026/0359629 A1
(43) Pub. Date: Nov. 12, 2026

(54) LEARNING DOMAIN SKILLS FOR IN-CONTEXT DECISION MAKING WITH ARTIFICIAL INTELLIGENCE

(71) Applicant: NEC Laboratories America, Inc., Princeton, NJ (US)

(72) Inventors: Wei Cheng, Princeton Junction, NJ (US); Haifeng Chen, West Windsor, NJ (US)

(21) Appl. No.: 19/662,755

(22) Filed: Apr. 29, 2026

Related U.S. Application Data
(60) Provisional application No. 63/804,134, filed on May 12, 2025.

(51) Int. Cl. G06N 3/08; G06N 3/042

(52) U.S. Cl. CPC G06N 3/08; G06N 3/042

(57) ABSTRACT

Systems and methods for learning domain skills for in-context decision making. Domain-level knowledge graphs can be constructed from trajectories sampled from performance data from a trained machine learning (ML) model based on action semantics and structural dependencies learned from the performance data. domain-level skills can be extracted with temporal difference learning that captures transferrable action transitions from the domain knowledge graphs. The trained ML model can be retrained with skill-based in-context learning that augments decision-making processing of the trained ML with prior knowledge and the domain-level skills to obtain a re-trained ML model for performing downstream tasks.

### RELATED APPLICATION INFORMATION

This application claims priority to U.S. Provisional App. No. 63/804,134, filed on May 12, 2025, incorporated herein by reference in its entirety.

### BACKGROUND

### Technical Field

The present invention relates to optimizing artificial intelligence models and more particularly learning domain skills for in-context decision making with artificial intelligence.

### Description of the Related Art

Artificial intelligence has been ubiquitous in our lives. Performing mundane tasks such as researching, simple logical reasoning, and data processing has been sped up with current advancements in developing artificial intelligence models.

### SUMMARY

According to an aspect of the present invention, a method is provided including, constructing domain knowledge graphs from trajectories sampled from performance data from a trained machine learning (ML) model based on action semantics and structural dependencies learned from the performance data, extracting domain-level skills with temporal difference learning that captures transferrable action transitions from the domain knowledge graphs, and retraining the trained ML model with skill-based in-context learning that augments decision-making processing of the trained ML with prior knowledge and the domain-level skills to obtain a re-trained ML model for performing downstream tasks.

According to another aspect of the present invention, a system is provided, including, a memory device, one or more processor devices operatively coupled with the memory device to perform operations including, constructing domain knowledge graphs from trajectories sampled from performance data from a trained machine learning (ML) model based on action semantics and structural dependencies learned from the performance data, extracting domain-level skills with temporal difference learning that captures transferrable action transitions from the domain knowledge graphs, and retraining the trained ML model with skill-based in-context learning that augments decision-making processing of the trained ML with prior knowledge and the domain-level skills to obtain a re-trained ML model for performing downstream tasks.

According to yet another aspect of the present invention, a non-transitory computer program product including a computer-readable storage medium including a program code, wherein the program code when executed on a computer causes the computer to perform operations including, constructing domain knowledge graphs from trajectories sampled from performance data from a trained machine learning (ML) model based on action semantics and structural dependencies learned from the performance data, extracting domain-level skills with temporal difference learning that captures transferrable action transitions from the domain knowledge graphs, and retraining the trained ML model with skill-based in-context learning that augments decision-making processing of the trained ML with prior knowledge and the domain-level skills to obtain a re-trained ML model for performing downstream tasks.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram that shows a system for learning domain skills for in-context decision making with artificial intelligence, in accordance with an embodiment of the present invention;

FIG. 2 is a block diagram that shows a computer system for learning domain skills for in-context decision making with artificial intelligence, in accordance with an embodiment of the present invention;

FIG. 3 is a block diagram that shows components of a computer system for learning domain skills for in-context decision making with artificial intelligence, in accordance with an embodiment of the present invention.

FIG. 4 is a block diagram that shows components of a domain knowledge graph constructor for learning domain skills for in-context decision making with artificial intelligence, in accordance with an embodiment of the present invention;

FIG. 5 is a block diagram that shows components of a domain skill extraction module for learning domain skills for in-context decision making with artificial intelligence, in accordance with an embodiment of the present invention;

FIG. 6 is a flow diagram that shows a high-level overview of learning domain skills for in-context decision making with artificial intelligence, in an embodiment of the present invention; and

FIG. 7 is a block diagram that shows a practical application for the re-trained machine learning model obtained by learning domain skills for in-context decision making with artificial intelligence, in accordance with an embodiment of the present invention.

### DETAILED DESCRIPTION OF PREFERRED EMBODIMENTS

In accordance with embodiments of the present invention, systems and methods are provided for learning domain skills for in-context decision making with artificial intelligence.

In the present embodiment, domain-level knowledge graphs can be constructed from trajectories sampled from performance data from a trained machine learning (ML) model based on action semantics and structural dependencies learned from the performance data. domain-level skills can be extracted with temporal difference learning that captures transferable action transitions from the domain knowledge graphs. The trained ML model can be retrained with skill-based in-context learning that augments decision-making processing of the trained ML with prior knowledge and the domain-level skills to obtain a re-trained ML model for performing downstream tasks.

Large language models (LLMs) are increasingly applied to multi-step decision-making tasks across domains such as embodied control, text-based games, and online shopping. These tasks require agents to operate in dynamic environments, interact with the world through sequences of actions, and pursue long-horizon goals.

In contrast to supervised fine-tuning (SFT) methods, which depend on large-scale expert demonstrations, in-context learning (ICL) offers a more lightweight and efficient alternative by guiding inference with only a few examples. Consequently, ICL has emerged as a central reasoning paradigm in many LLM-based agent frameworks for decision-making. To make ICL effective for multi-step task, prompt design should adhere to these principles:

Focused: emphasize decision-critical information while minimizing redundant context. Granular: offer fine-grained, step-level guidance that aligns to the evolving task state. Label-efficient: reduce reliance on expert-annotated trajectories by leveraging weaker forms of supervision, such as sub-goal completion rate and success feedback.

Recent work has improved the effectiveness of ICL by moving beyond static prompts toward more context sensitive designs.

Static prompting relies on fixed templates that ignore task-specific context. Although label-free, static prompts fail to provide actionable, decision-level guidance.

Task-level retrieval methods, retrieve full expert demonstrations based on task metadata and use them as few-shot exemplars. While this improves contextual relevance, the retrieved prompts often include redundant steps and lack step-level resolution, limiting both focus and granularity.

Step-level retrieval strategies enhance granularity by retrieving trajectory fragments at each decision step. However, the retrieved actions are often disconnected and lack structural coherence, which undermines decision focus. These methods also rely on expert-annotated data, reducing their label-efficiency.

Insight summarization approaches generate high-level insights by comparing correct and wrong solutions. Yet these summarized insights are often too abstract to support intermediate decision, providing limited fine-grained guidance.

While each of these approaches addresses different aspects of prompt design, none of them simultaneously meet all principles.

To address these limitations, a skill-based ICL framework that extracts and applies both domain-level and action-centric skills can be utilized which leverages sub-goal completion signals annotated in the training set as a form of weak supervision. To ensure focused reasoning, the present embodiments construct prompts around decision-critical skill segments, reducing irrelevant context and emphasizing pivotal actions. To enable fine-grained guidance, the present embodiments encode temporal and structural dependencies among reusable action sequences in the domain-level graph, enabling precise skill retrieval aligned with task history. To promote label-efficiency, the present embodiments rely on sub-goal feedback and TD-estimated action values, enabling skill extraction without expert annotations.

As such, the present embodiments resolve the limitations of artificial intelligence (AI) decision making when there are sparse training data and when there is a limited observable space of the domain environment. By utilizing the present embodiments, the amount of training data for an AI model can be reduced while increasing the accuracy of performance of the decision-making ability of the trained machine learning model.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

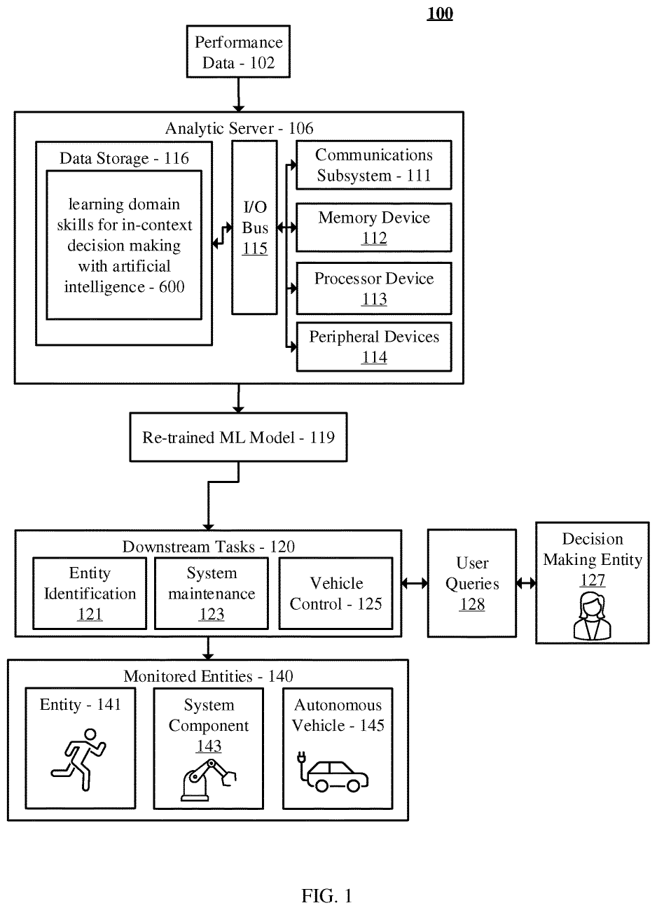

Referring now in detail to the figures in which like numerals represent the same or similar elements and initially to FIG. 1, a block diagram shows a system for learning domain skills for in-context decision making with artificial intelligence, in accordance with an embodiment of the present invention.

In an embodiment using a system 100, monitored entities 140 can include entity 141, system component 143, and autonomous vehicle 145. The monitored entities 140 can generate an input dataset that include image/video 102. The image/video 102 can be transmitted to an analytic server 106 that can implement learning domain skills for in-context decision making with artificial intelligence 600. The analytic server 106 can be utilized to train a machine learning model and obtain a re-trained machine learning model 119. The re-trained machine learning model 119 can be utilized to perform downstream tasks 120.

System 100 can be utilized to perform downstream tasks 120 based on the performance data 102 and user queries 128 from a decision-making entity 127. The downstream tasks 120 can include entity identification 121, system maintenance 123, and vehicle control 125. The analytic server 106 can generate a corrective action for the downstream tasks 120 to be sent to respective computing systems for the monitored entities 140 through a network.

In entity identification 121, the performance data 102 (e.g., location images, scene images, entity images such as parts of the entity, etc.) related to the entity 141 can be processed by the analysis server 106 to answer user queries 128. The user queries 128 can be relevant to the entity 141 such as their attributes (e.g., position, direction of movement, color of clothing, etc.), relationship with other entities within a scene (e.g., proximity, behavior, etc.), relationship with the environment, etc. The re-trained machine learning model 119 can predict future attributes, and relationships of the entity 141.

Based on the predictions of the re-trained machine learning model 119, a corrective action can be generated. The corrective action can include notifying the decision making entity 127 of the predictions about the entity 141 based on their performance data 102, generating resolutions to an issue caused by the entity (e.g., the entity 141 as a disabled vehicle in a traffic scene and the resolution is the deployment of a repair technician, etc.) of the performance data 102 to help with the decision making process of the decision making entity 127, etc.

In system maintenance 123, performance data 102 (e.g., system logs, test cases, hardware status images, etc.) related to the system component 143 can be processed to answer user queries 128. The user queries 128 can be relevant on how to properly maintain the system component 143 based on the performance data 102. A corrective action can be generated by the analytic server 106 which can include the answer to the user queries 128 (e.g., determine causes to bandwidth issues, etc.) to maintain the system component 143. Based on the corrective action (e.g., adding bandwidth, blocking packets from an identified internet protocol (IP) address to resolve malicious attacks, restarting hardware, etc.) the network system can be autonomously maintained.

In vehicle control 125, performance data 102 (e.g., vehicle part status, traffic scene image, etc.) related to the autonomous vehicle 145 can be processed to answer user queries 128. The user queries 128 can be relevant to how to control the autonomous vehicle 145 given its environment based on the performance data 102. A corrective action can be generated by the analytic server 106 which can include the answer to the user queries 128 to control the proper performance of the autonomous vehicle 145. Based on the corrective action (e.g., stopping, speeding up, changing direction, etc.) the autonomous vehicle 145 can be autonomously controlled using appropriate control devices (e.g., advanced driver assistance systems, braking device, accelerator device, cooling device, etc.) within the autonomous vehicle. In an embodiment, the autonomous vehicle 145 can be controlled in response to avoid a predicted event based on a generated trajectory such as multi-vehicle collision, accidents, detected road hazards, etc.

In another embodiment, in vehicle control 125, the autonomous vehicle 145 can be controlled to verify and test the functionality of the various components (e.g., advanced driver assistance systems, braking device, accelerator device, cooling device, etc.) of the autonomous vehicle 145 by autonomously controlling the components and generate test data that can be used to fine-tune/train the re-trained machine learning model 119.

Other downstream tasks and practical applications are contemplated.

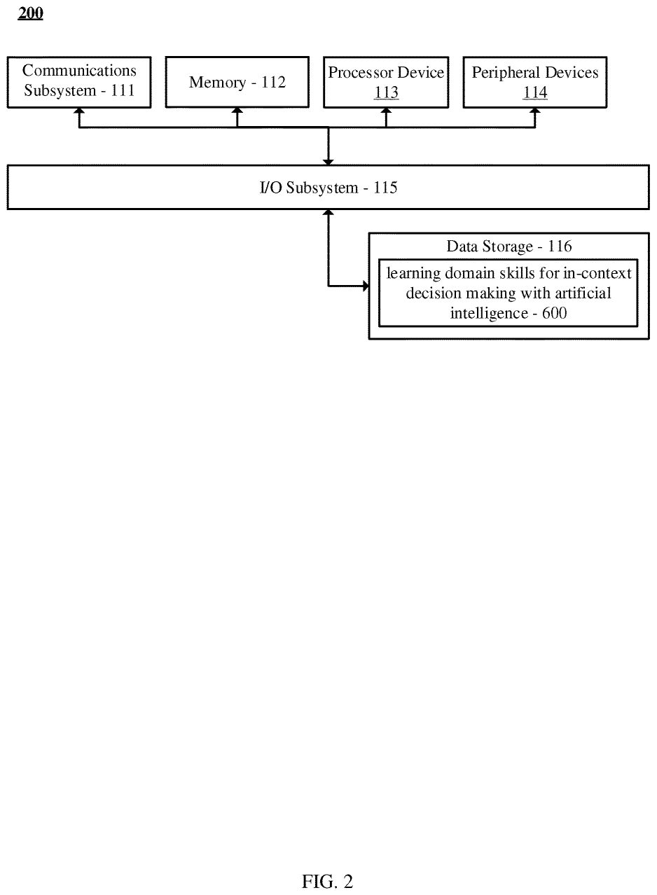

The analytic server 106 can include a processor device 113, data storage device 116, memory 112, communications subsystem 111, peripheral devices 114, and input/output (I/O) bus 115. The analytic server 106 is an implementation of a computer system. Other implementations are contemplated. The computer system is shown in more detail in FIG. 2.

Referring now to FIG. 2, a block diagram shows a computer system for learning domain skills for in-context decision making with artificial intelligence, in accordance with an embodiment of the present invention.

The computing device 200 illustratively includes the processor device 113, an input/output (I/O) subsystem 190, a memory 112, a data storage device 116, and a communications subsystem 111, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 112, or portions thereof, may be incorporated in the processor device 113 in some embodiments.

The processor device 113 may be embodied as any type of processor capable of performing the functions described herein. The processor device 113 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 112 may be embodied as any type of volatile or non-volatile memory or data storage capable of performing the functions described herein. In operation, the memory 112 may store various data and software employed during operation of the computing device 200, such as operating systems, applications, programs, libraries, and drivers. The memory 112 is communicatively coupled to the processor device 113 via the I/O subsystem 115, which may be embodied as circuitry and/or components to facilitate input/output operations with the processor device 113, the memory 112, and other components of the computing device 200. For example, the I/O subsystem 115 may be embodied as, or otherwise include, memory controller hubs, input/output control hubs, platform controller hubs, extracted control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 115 may form a portion of a system-on-a-chip (SOC) and be incorporated, along with the processor device 113, the memory 112, and other components of the computing device 200, on a single extracted circuit chip.

The data storage device 116 may be embodied as any type of device or devices configured for short-term or long-term storage of data such as, for example, memory devices and circuits, memory cards, hard disk drives, solid state drives, or other data storage devices. The data storage device 116 can store program code for learning domain skills for in-context decision making with artificial intelligence 600. Any or all of these program code blocks may be included in a given computing system.

The communications subsystem 111 of the computing device 200 may be embodied as any network interface controller or other communication circuit, device, or collection thereof, capable of enabling communications between the computing device 200 and other remote devices over a network. The communications subsystem 111 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 114. The peripheral devices 114 may include any number of additional input/output devices, interface devices, and/or other peripheral devices. For example, in some embodiments, the peripheral devices 114 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

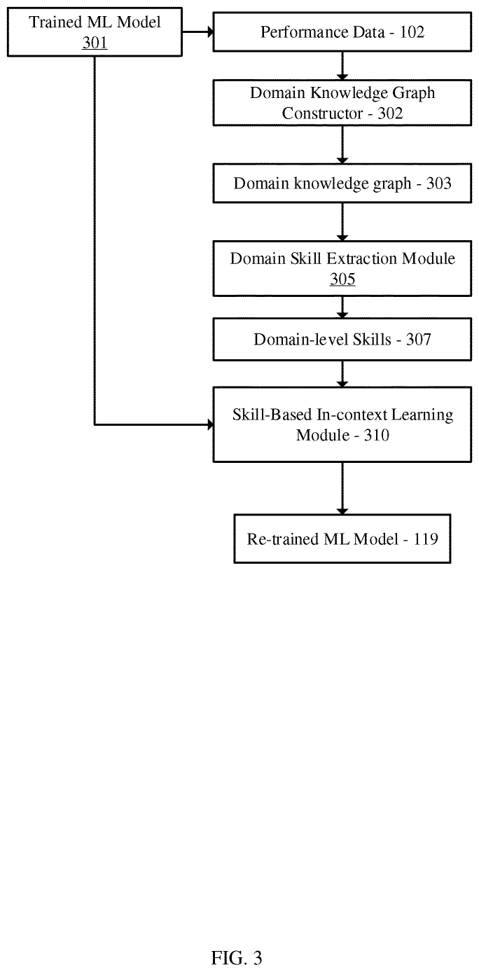

Referring now to FIG. 3, a block diagram shows components of a computer system for learning domain skills for in-context decision making with artificial intelligence, in accordance with an embodiment of the present invention.

In an embodiment, performance data 102 can be obtained from a trained machine learning (ML) model 301 and processed to obtain a re-trained ML model 119. The performance data 102 can be processed by a domain knowledge graph constructor 302 to obtain a domain knowledge graph 303 from the performance data 102. The domain knowledge graph 303 can be processed by a domain skill extraction module 305 and obtain domain-level skills 307 from the performance data 102. The domain-level skills 307 can be utilized by a skill-based in-context learning module 310 to train the trained ML model 301 and obtain the re-trained ML model 119. The re-trained ML model 119 can be utilized to perform downstream tasks 120.

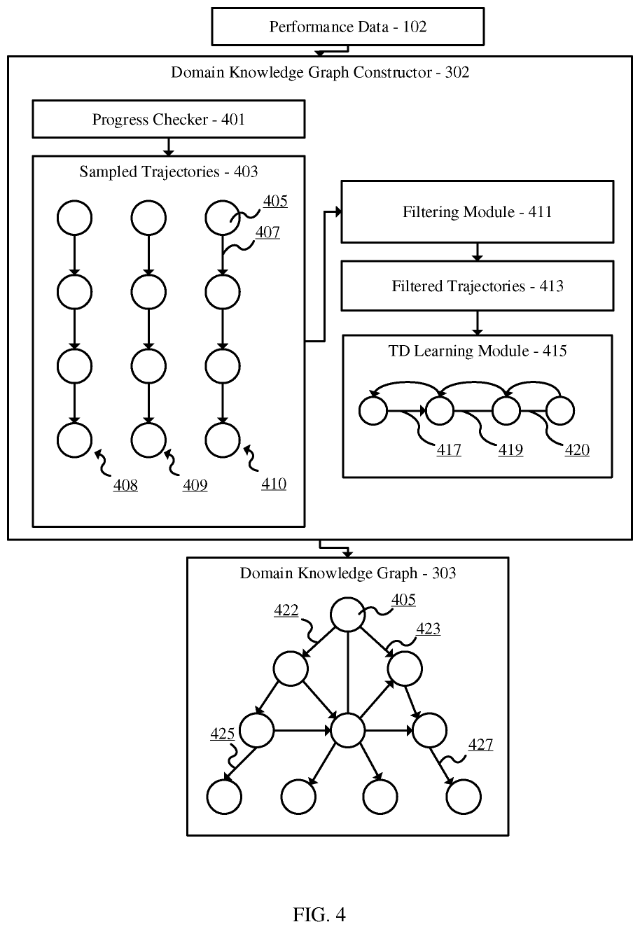

Referring now to FIG. 4, a block diagram shows components of a domain knowledge graph constructor for learning domain skills for in-context decision making with artificial intelligence, in accordance with an embodiment of the present invention.

In an embodiment, the domain knowledge graph constructor 302 can process performance data 102 to generate domain knowledge graph 303. The domain knowledge graph constructor 302 can include a progress checker 401, a filtering module 411, and a temporal difference (TD) learning module 415.

The progress checker 401 can process and monitor the performance data 102 to obtain sampled trajectories 403. The sampled trajectories 403 include an action 405 and a progress metric 407.

The action 405 can include data utilized by the trained ML model 301 to perform tasks (e.g., 408, 409, 410). For example, for an image processing task 408, action 405 can include generating image embeddings from an input image.

The progress metric 407 can include data on how far along the current action is within the entire task. For example, in the image processing task 408, action 405 is the first action out of three actions of the image processing task 408, as such, the progress metric 407 can include a 33% completion metric. If the action has no bearing in the completion of the task, the progress metric 407 can include a 0% completion metric. The progress metric 407 can include efficiency metrics such as completion time, computational resources utilized, (e.g., memory, compute complexity, etc.), etc.

The sampled trajectories 403 can include similar tasks within the same domain (e.g., image processing, etc.) or different tasks within different domains (e.g., image processing, audio processing, etc.). For example, tasks 408, 409, 410 can be all tasks within the image processing domain or task 408 can be in the image processing domain while 409 and 410 are in the audio processing domain.

The sampled trajectories 403 can be processed by the filtering module 411 to obtain filtered trajectories 413 to ensure that the actions relevant to the completion of the task are obtained.

The filtered trajectories 413 can be processed by the TD learning module 415 to obtain the domain knowledge graph 303. The TD learning module 415 can determine differences and similarities between actions 405 of the filtered trajectories 413 and identify high-impact actions 405 of the filtered trajectories 413. The TD learning module 415 can determine TD updates 417, 419, 420 between actions 405 in an iterative manner. The TD updates summarize the differences and similarities between the actions 405 and their corresponding progress metrics 407.

After convergence, the TD learning module 415 can generate the domain knowledge graph 303. The domain knowledge graph 303 can include action 405 and their corresponding edge-wise skill score (ESS) (e.g., 422, 423, 425, 427). The edge-wise skill scores can have greater values than others. For example, ESS 422 can be greater than ESS 423, ESS 425 can be greater than ESS 427.

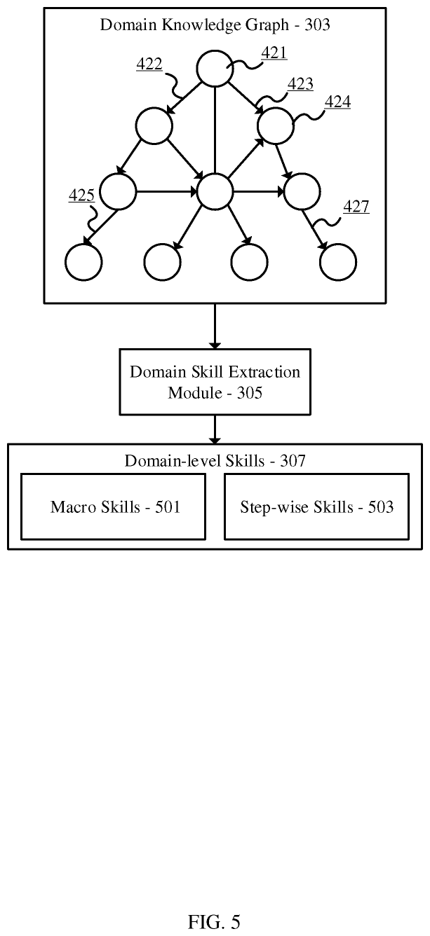

Referring now to FIG. 5, a block diagram shows components of a domain skill extraction module for learning domain skills for in-context decision making with artificial intelligence, in accordance with an embodiment of the present invention.

In an embodiment, the domain knowledge graph 303 can be processed by a domain skill extraction module 305 to obtain domain-level skills 307 which includes macro skills 501 and step wise skills 503. The macro skills 501 can be determined from tasks 410, 409, 408 which can correspond to actions 405 of the domain knowledge graph 303. For example, the macro skills 501 can include learning image embeddings from an input image for an image processing task 410. The step wise skills 503 can be determined from actions 405 that are within the same domain as the macro skills 501 and are logical steps for the macro skills 501. For example, in the macro skills 501 for learning image embeddings, the step wise skills 503 can include determining pixels for a region of interest within an input image. The macro skills 501 and the step wise skills 503 can be utilized by the skill-based in-context learning module 310 to train the trained ML model 301 and obtain a re-trained ML model 119. In an embodiment, the trained ML model 301 and the re-trained ML model 119 can utilize neural networks.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network, such as a multilayer perceptron, can have an input layer of source neurons, one or more computation layer(s) having one or more computation neurons, and an output layer, where there is a single output neuron for each possible category into which the input example could be classified. An input layer can have a number of source neurons equal to the number of data values in the input data. The computation neurons in the computation layer(s) can also be referred to as hidden layers, because they are between the source neurons and output neuron(s) and are not directly observed. Each neuron in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

Training a deep neural network can involve two phases, a forward phase where the weights of each neuron are fixed and the input propagates through the network, and a backwards phase where an error value is propagated backwards through the network and weight values are updated. The computation neurons in the one or more computation (hidden) layer(s) perform a nonlinear transformation on the input data that generates a feature space. The classes or categories may be more easily separated in the feature space than in the original data space.

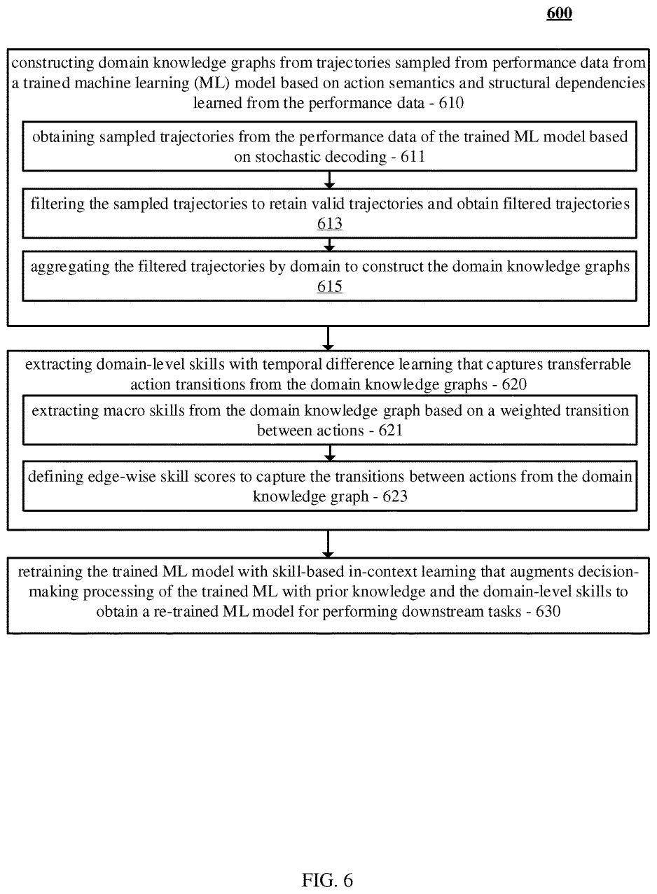

Referring now to FIG. 6, a flow diagram shows a high-level overview of learning domain skills for in-context decision making with artificial intelligence, in an embodiment of the present invention.

In an embodiment, domain-level knowledge graphs can be constructed from trajectories sampled from performance data from a trained machine learning (ML) model based on action semantics and structural dependencies learned from the performance data. domain-level skills can be extracted with temporal difference learning that captures transferrable action transitions from the domain knowledge graphs. The trained ML model can be retrained with skill-based in-context learning that augments decision-making processing of the trained ML with prior knowledge and the domain-level skills to obtain a re-trained ML model for performing downstream tasks.

In block 610, domain-level knowledge graphs can be constructed from trajectories sampled from performance data from a trained machine learning model based on action semantics and structural dependencies learned from the performance data.

In block 611, sampled trajectories can be obtained from the performance data of the trained machine learning model based on stochastic decoding. In an embodiment, given each training instance d=(m,o)∈Dₜᵣₐᵢₙ from performance data 102, N distinct trajectories can be generated and sampled using stochastic decoding, yielding a training trajectory set of sampled trajectories 403: [symbol] ₜᵣₐᵢₙ={(m,o,τ)|(m,o)∈Dₜᵣₐᵢₙ}, τ={(s₀,a₀,p₀), . . . , (s_{T},a_{T},p_{T})}, where each t is a sequence of state-action-progress tuples.

In block 613, the sampled trajectories can be filtered to retain valid trajectories and obtain filtered trajectories. In an embodiment, since raw trajectories can include ineffective actions, the sampled trajectories 403 can be filtered to retain only valid steps. Specifically, actions not in the environment's valid action set can be removed. The valid action set can include trajectories that account to a task's final progress. For trajectories with non-zero final progress, filtered trajectories 413 can be defined as: τ′={(s₀,a₀,p₀), . . . , (s_{T′},a_{T′},p_{T′})}, with p_{T′}>0, where each action at is factored into a task-invariant action type âₜ∈Â and a task-specific parameter θₜ.

To unify and aggregate behaviors across instances of the same task domain, instance-specific parameters can be abstracted and focus on action types. The filtered trajectories 413 can be represented as: τₘ={(â,p₀), . . . ,(â_{T′},p_{T′})}, with p_{T′}>0.

In block 615, the filtered trajectories can be aggregated by domain to construct the domain knowledge graph. In an embodiment, the filtered trajectories 413 τₘ can be aggregated by domain to construct a domain knowledge graph [symbol] ₘ=( [symbol] ), where:

$$𝕍 = \{ ( \hat{a} , \overline{p} ( \hat{a} ) ) \vert \hat{a} ∈ \hat{A} \} , \overline{p} ( \hat{a} ) = \frac{1}{\vert {𝕋}_{\hat{a}} \vert} {\sum }_{τ ∈ {𝕋}_{\hat{a}}} {p}_{τ} ( \hat{a} ) ,$$

[symbol]

={((âᵢ,p̅ᵢ),(âⱼ,p̅ⱼ))|∃τ∈τₘ, (âᵢ,âⱼ) consecutive in τ}, [symbol] _{â} denotes all trajectories containing â, and p̅(â) represents its average contribution. The resulting graph encodes action semantics and structural dependencies within a domain, laying the foundation for skill extraction and rule-guided reasoning.

In block 620, domain-level skills can be extracted from the domain knowledge graph with temporal difference learning that captures transferrable action transitions for downstream tasks.

In block 621, macro skills can be extracted from the domain knowledge graph based on a weighted transition between actions. In an embodiment, a structured set of domain-level skills 307 Φ can be extracted, each represented as a weighted transition between two abstract actions, can be extracted from the domain knowledge graph [symbol] ₘ=( [symbol] ). These weighted transitions capture reusable behavior patterns observed across successful trajectories. Formally, the domain-level skills 307 can be defined as: φ={(φᵢ,ψᵢ,θᵢ)|(φᵢ,ψᵢ)∈ [symbol] ,θᵢ=θ(φᵢ,ψᵢ), where φᵢ,ψᵢ=Â denote source and target actions, and θᵢ is the edge-wise utility score derived from TD learning.

In block 623, Temporal Difference (TD) learning can be applied iteratively over the filtered trajectories until convergence. In an embodiment, TD learning can be applied to the filtered trajectories 413 [symbol] ₘ, where each trajectory

$$τ = {\{ ( {\hat{a}}_{t} , {\hat{p}}_{t} ) \}}_{t = 0}^{T}$$

is composed of actions 405 and corresponding progress metrics 407. The TD update is: δₜ=(pₜ₊₁−pₜ)+γQ(âₜ₊₁)−Q(âₜ), with Q-values updated as: E(âₜ)←E(âₜ)+1, Q(â)←Q(â)+αδ_{T}e(â),E(â)←γλe(â), where α is the learning rate, γ is the discount factor, λ is the trace decay, and E is the expected value. Updates iterate until convergence:

$${max}_{\hat{a} ∈ \hat{A}} \vert {Q}^{k + 1} ( \hat{a} ) - {Q}^{k} ( \hat{a} ) \vert < ϵ .$$

In block 625, edge-wise skill scores can be defined to capture the transitions between actions from the domain knowledge graph. In an embodiment, after convergence, the edge-wise skill score can be defined by:

$$θ ( ϕ , ψ ) := θ ( ψ ) = \frac{1}{Z} Q ( ψ ) , Z = {\sum }_{{\hat{a}}^{′}} {Q}^{k} ( {\hat{a}}^{′} ) ,$$

which reflects the expected utility of reaching action ψ from any source φ. The domain-level skills 307 Φ thus captures high-utility, transferable action transitions for downstream knowledge-augmented LLM decision-making.

In block 630, the trained ML model can be retrained with skill-based in-context learning based on the domain-level skills to obtain a re-trained ML model for performing downstream tasks. In an embodiment, to support efficient reasoning in multi-step decision-making, a skill-augmented training method such as skill-based in-context learning can be employed that conditions a frozen large language model (LLM) on both the agent's interaction history and a set of retrieved skills from the domain knowledge graph. This allows the model to leverage prior experience in the form of reusable domain transitions. This can be formulated as a set Φ of domain-level skills 307 relevant to the current interaction context. A domain-level skill 307 φ∈Φ is defined as a short sequence of high-utility actions: φ=(a₁, a₂, . . . , aₖ), aᵢ∈A, k≤L. The domain-level skills 307 are extracted from training trajectories based on their contribution to task progress, and represent reusable behavior patterns commonly effective across related tasks.

In-context learning (ICL) can be modeled as an implicit Bayesian inference process. In this view, the trained ML model 301 such as a large language model (LLM) implicitly infers a latent task parameter θ∈θ based on the observed context C (e.g., a sequence of demonstrations or interaction history). The trained ML model 301 forms a posterior over latent concepts p(θ|C), and makes predictions for a new query x by computing the posterior predictive distribution: p(y|x,C)=∫_{θ}p(y|x,θ)p(θ|C)dθ, (1) where x∈X denotes the query input, y∈Y denotes the predicted output, p(y|x,θ) is the likelihood under latent parameter θ. Thus, ICL can be interpreted as posterior inference over an underlying task concept θ, conditioned on the prompt context C.

In skill-based in-context learning, at each decision step t, the agent of the trained machine learning model 301 has access to a partial observation-action history hₜ={(o₀,a₀), . . . , (oₜ₋₁,aₜ₋₁),oₜ}. The query action for skill retrieval can be defined as

$${q}_{t} = \{ \begin{matrix}init state , & if t = 0 \\ {a}_{t - 1} , & otherwise\end{matrix} .$$

To retrieve relevant prior knowledge, the embedding of qₜ can be computed using a pretrained encoder f_{enc}: Â=> [symbol] ^{d}, yielding the query vector qₜ=f_{enc}(qₜ). Each abstract action âⱼ in the domain knowledge graph 303 [symbol] ₘ=(V, E) is also embedded as aⱼ=f_{enc}(qₜ). Cosine similarity can be computed between the query and all candidate nodes:

$$sim ( {q}_{t} , {a}_{j} ) = \frac{{q}_{t}^{T} {a}_{j}}{‖ {q}_{t} ‖ \cdot ‖ {a}_{j} ‖} .$$

In another embodiment, other similarity methods can be utilized such as Euclidean distance. The top-K nearest neighbors can be selected Nₜ={â₍₁₎, . . . , â_{(K)}} based on similarity ranking to collect adjacent skills from each retrieved node â₍ₖ₎∈Nₜ from the domain knowledge graph. The adjacent skills include forward transitions (â₍ₖ₎,ψ) and backward transitions (φ,â₍ₖ₎), where (φ,ψ)∈ [symbol] . The full set of retrieved transitions can be denoted as

$${C}_{t} = {U}_{k = 1}^{K} \{ ( ϕ , {\hat{a}}_{( k )} , θ ( ϕ , {\hat{a}}_{( k )} ) ) \vert ( ϕ , {\hat{a}}_{( k )} ) ∈ 𝔼 \} ⋃ \{ ( {\hat{a}}_{( k )} , ψ , θ ( {\hat{a}}_{( k )} , ψ ) ) \vert ( {\hat{a}}_{( k )} , ψ ) ∈ 𝔼 \} .$$

A final prompt can be constructed by serializing both the agent history hₜ and the retrieved skill transitions Cₜ to train the trained machine learning model with the domain-level skills. Let Format(⋅) denote a deterministic mapping from structured inputs to natural language. The prompt is given by Prompt (hₜ,Cₜ)=Format (hₜ)+Σ_{(φ,ψ,θ)∈C}_{ₜ} Format (φ, ψ, θ). The trained ML model 301 then selects the next action at by autoregressively sampling from π(aₜ|hₜ,Cₜ)=LLM (aₜ|Prompt (hₜ, Cₜ)).

The re-trained ML model 119 resolves the problem of multi-step decision-making in partially observable environments, where agents operate under uncertainty, interact using natural language, and receive delayed feedback. This setting can be modeled as a Partially Observable Markov Decision Process (POMDP): POMDP=(S, A, Ω, P, R, O), where S denotes the latent state space, A the discrete action space, Ω the observation space, P the state transition function, R a sparse, progress-based reward function, and O the observation model. At each time step t, the agent receives a partial observation oₜ=0 (oₜ|sₜ) and selects an action at based on the interaction history: hₜ={(o₀,a₀),(o₁,a₁), . . . ,oₜ}. The agent policy is parameterized by an LLM and implemented via in-context learning. Given the current history hₜ, the LLM generates the next action through a prompting mechanism: π(aₜ|hₜ)=LLM (aₜ|Prompt (hₜ)). This formulation enables machine learning models such as LLMs to serve as decision-making agents in partially observable settings, leveraging contextual information without access to full environment states or explicit policy optimization. The agent aims to maximize cumulative task progress over long-horizon episodes. The re-trained ML model 119 can then be utilized to perform downstream tasks 120.

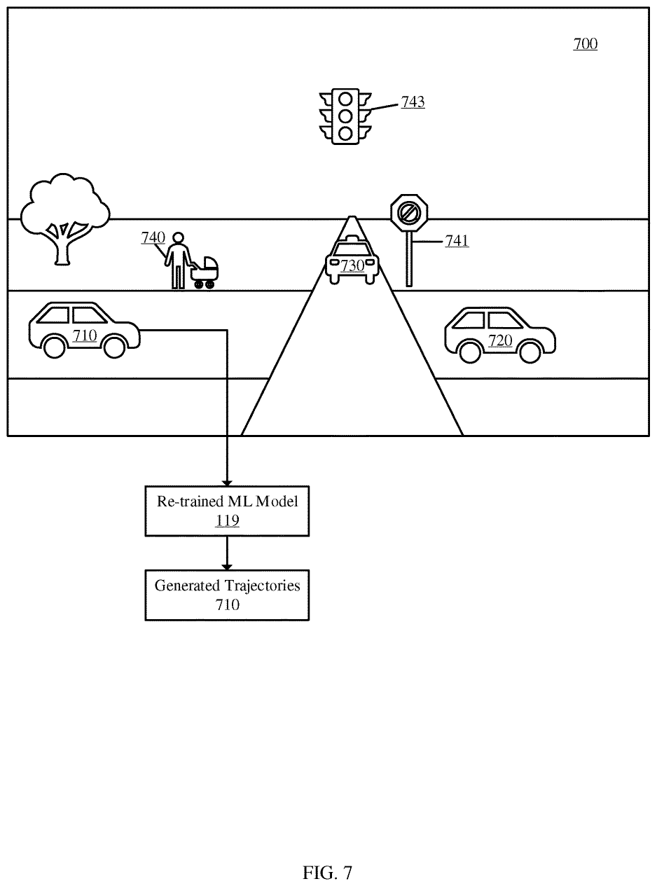

Referring now to FIG. 7, a block diagram shows a practical application for the re-trained machine learning model obtained by learning domain skills for in-context decision making with artificial intelligence, in accordance with an embodiment of the present invention.

In an embodiment, in traffic scene 700, vehicle 710 can communicate with analytic server 106 through a network. User queries 128 can be communicated to vehicle 710 through an artificial intelligence (AI) agent that can communicate with the analytic server 106. The user queries 128 can include commands to control vehicle 710 such as controlling the components of the vehicle (e.g., air quality control, entertainment components such as radio, etc.) and controlling the trajectory of the vehicle (e.g., speeding up, braking, change direction, etc.) through autonomous decision making based on domain-skills learned with the re-trained ML model 119.

The re-trained ML model 119 can generate predictions of trajectories of the entities in the traffic scene 700 as generated trajectories 710. For example, the generated trajectories 710 can include the following: “it is safe to cross the intersection and overtake vehicle (720) that is in the intersection as pedestrian (740) is crossing parallel to the intersection and taxi (730) is stopped behind one-way sign (741) as the light on (743) is red for taxi (730) and green for vehicle (720).”

In another embodiment, in the healthcare space, there is a prevalent issue one-size-fits-all wellness solutions as ineffective as a person's adaptation to adverse stimuli such as stress of people are highly personal. Additionally, it is difficult to assess a person's stress level which makes correcting the causes of adverse stimuli difficult. Moreover, there is a high failure rate in building and maintaining wellness habits.

To resolve these issues, the re-trained ML model 119 can automatically extract and model effective behavioral sequences that reduced stress as “Wellness Skills,” using data from wearable devices (heart rate variability (HRV), mood logs, etc.). Additionally, the re-trained ML model 119 can detect the decision-making entity's real-time state (e.g., a drop in HRV), retrieve the most relevant “skill” for the context, and suggest a personalized action, such as “Let's try a 1-minute breathing exercise now.”

As such, the re-trained ML model 119 can deliver effective, data-driven stress-coping strategies for the decision-making entities in real time. Additionally, the re-trained ML model 119 can foster the adoption of positive behaviors (e.g., breathing, meditation) into daily life through timely and actionable suggestions. Moreover, the re-trained ML model 119 can catch early signs of stress and addresses them before they escalate, supporting long-term mental well-being.

In another embodiment, in autonomous policy generation with an artificial intelligence agent, there is a prevalent issue where the agent misinterprets the cause of an exception (e.g., misjudging the reason for a “hold”), leading to incorrect actions. This results in delivery delays and increased costs due to lengthy manual investigations.

To resolve these issues, the re-trained ML model 119 can process the agent's failed execution trajectory (API calls, thought process, action selection) to be fed into Agent Debugger. The re-trained model 119 can verify learned rules like “No corrective action without root cause identification” and identify errors by referencing similar failure cases. After verification, the re-trained model 199 can generate a natural language report: “Cause: Incorrect inference from ambiguous data” and “Recommendation: Contact carrier to confirm the reason.”

As such, the re-trained ML model 119 can drastically reduce operator investigation time through rapid root cause analysis, prevent opportunity loss and additional costs through accurate initial response, and enhance AI reliability using accumulated error data with continuous agent improvement.

In another embodiment, the re-trained ML model 119 can optimize the workflow for a connected data management system such as financial systems. There is a prevalent issue with AI agents utilized for connected data management systems where the agent misinterprets system data (e.g., including irrelevant data such as non-operating income in sales revenue) which can lead to rejections of viable applications, causing opportunity loss.

To resolve these issues, the re-trained ML model 119 can utilize the agent's suspended execution trajectory (PDF reading area, data extraction, calculation logic) is fed into a Debugger. The re-trained ML model 119 can then verify learned rules such as “Exclude injection, ‘transfer’ from calculation.” and identify the errors with the workflow. After verification, the re-trained model 199 can generate a natural language report: “Cause: irrelevant data included” and “Recommendation: Recalculate excluding these items.”

As such, the re-trained ML model 119 reduces manual rework and prevents judgment errors through increased screening accuracy, avoids rejection of good applications, and strengthens the agent's ability to handle diverse document formats through continuous agent improvement.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method, comprising:
constructing domain knowledge graphs from trajectories sampled from performance data from a trained machine learning (ML) model based on action semantics and structural dependencies learned from the performance data;
extracting domain-level skills with temporal difference learning that captures transferrable action transitions from the domain knowledge graphs; and
retraining the trained ML model with skill-based in-context learning that augments decision-making processing of the trained ML with prior knowledge and the domain-level skills to obtain a re-trained ML model for performing downstream tasks.

2. The method of claim 1, wherein constructing the domain-level knowledge graphs further comprises obtaining sampled trajectories from the performance data of the trained ML model based on stochastic decoding.

3. The method of claim 2, wherein constructing the domain-level knowledge graphs further comprises filtering the sampled trajectories to retain valid trajectories and obtain filtered trajectories.

4. The method of claim 3, wherein constructing the domain-level knowledge graphs further comprises aggregating the filtered trajectories by domain to construct the domain knowledge graphs.

5. The method of claim 1, wherein extracting the domain-level skills further comprises extracting macro skills from the domain knowledge graph based on a weighted transition between actions.

6. The method of claim 5, wherein extracting the domain-level skills further comprises defining edge-wise skill scores to capture the transitions between actions from the domain knowledge graph.

7. The method of claim 1, wherein the downstream tasks include verifying a generated recommendation based on performance data of the trained machine learning model for processing healthcare data to correct issues with an autonomous decision-making process of the trained machine learning model.

8. A system, comprising:
a memory device;
one or more processor devices operatively coupled with the memory device to perform operations including:
constructing domain knowledge graphs from trajectories sampled from performance data from a trained machine learning (ML) model based on action semantics and structural dependencies learned from the performance data;
extracting domain-level skills with temporal difference learning that captures transferrable action transitions from the domain knowledge graphs; and
retraining the trained ML model with skill-based in-context learning that augments decision-making processing of the trained ML with prior knowledge and the domain-level skills to obtain a re-trained ML model for performing downstream tasks.

9. The system of claim 8, wherein constructing the domain-level knowledge graphs further comprises obtaining sampled trajectories from the performance data of the trained ML model based on stochastic decoding.

10. The system of claim 9, wherein constructing the domain-level knowledge graphs further comprises filtering the sampled trajectories to retain valid trajectories and obtain filtered trajectories.

11. The system of claim 10, wherein constructing the domain-level knowledge graphs further comprises aggregating the filtered trajectories by domain to construct the domain knowledge graphs.

12. The system of claim 8, wherein extracting the domain-level skills further comprises extracting macro skills from the domain knowledge graph based on a weighted transition between actions.

13. The system of claim 12, wherein extracting the domain-level skills further comprises defining edge-wise skill scores to capture the transitions between actions from the domain knowledge graph.

14. The system of claim 8, wherein the downstream tasks include verifying a generated recommendation based on performance data of the trained machine learning model for processing healthcare data to correct issues with an autonomous decision-making process of the trained machine learning model.

15. A non-transitory computer program product comprising a computer-readable storage medium including a program code, wherein the program code when executed on a computer causes the computer to perform operations including:
constructing domain knowledge graphs from trajectories sampled from performance data from a trained machine learning (ML) model based on action semantics and structural dependencies learned from the performance data;
extracting domain-level skills with temporal difference learning that captures transferrable action transitions from the domain knowledge graphs; and
retraining the trained ML model with skill-based in-context learning that augments decision-making processing of the trained ML with prior knowledge and the domain-level skills to obtain a re-trained ML model for performing downstream tasks.

16. The non-transitory computer program product of claim 15, wherein constructing the domain-level knowledge graphs further comprises obtaining sampled trajectories from the performance data of the trained ML model based on stochastic decoding.

17. The non-transitory computer program product of claim 16, wherein constructing the domain-level knowledge graphs further comprises filtering the sampled trajectories to retain valid trajectories and obtain filtered trajectories.

18. The non-transitory computer program product of claim 17, wherein constructing the domain-level knowledge graphs further comprises aggregating the filtered trajectories by domain to construct the domain knowledge graphs.

19. The non-transitory computer program product of claim 15, wherein extracting the domain-level skills further comprises extracting macro skills from the domain knowledge graph based on a weighted transition between actions obtained through edge-wise skill scores.

20. The non-transitory computer program product of claim 15, wherein the downstream tasks include verifying a generated recommendation based on performance data of the trained machine learning model for processing healthcare data to correct issues with an autonomous decision-making process of the trained machine learning model.
